(19) United States
(12) Patent Application Publication
(10) Pub. No.: US 2016/0296958 A1
(43) Pub. Date: Oct. 13, 2016

(54) LIQUID DISPENSER WITH PUMP

(71) Applicant: EOS PRODUCTS, LLC, New York, NY (US)

(72) Inventors: Jonathan Teller, New York, NY (US); Sanjiv Mehra, Scarsdale, NY (US); Peter Waxman, Armonk, NY (US); Joseph Speter, New York, NY (US); Sherry Jhawar, New York, NY (US); Karim Rashid, New York, NY (US); Bart Ruijpers, New York, NY (US); Frank Zaremba, New York, NY (US)

(21) Appl. No.: 15/093,159

(22) Filed: Apr. 7, 2016

Related U.S. Application Data
(60) Provisional application No. 62/144,245, filed on Apr. 7, 2015.

(51) Int. Cl. B05B 11/00

(52) U.S. Cl. CPC B05B 11/3001; B05B 11/3047; B05B 11/3052

(57) ABSTRACT

A liquid dispenser includes a bottle having a lower portion, an upper portion, and a neck portion located above the upper portion. The upper portion and the neck portion are vertically aligned with a central vertical axis. A pump is coupled to the neck portion and dispenses liquid by moving the pump from an un-depressed position to a depressed position. The pump includes a pump mechanism, an orifice in fluid communication with the pump mechanism to enable liquid to be dispensed, and a tube in fluid communication with the pump mechanism and extending into the lower portion. A shroud forms at least a portion of the outer surface of the pump. The shroud is positioned to cover the neck portion and a portion of the upper portion in the un-depressed position and cover the neck portion and a larger portion of the upper portion in the depressed position.

### CROSS-REFERENCE TO RELATED APPLICATIONS

This application claims the benefit of U.S. Provisional Application No. 62/144,245, filed Apr. 7, 2015; is related to U.S. Design application Ser. No. 29/523,221, filed on Apr. 7, 2015, entitled CONTAINER, BOTTLE, LOTION DISPENSER AND/OR PORTIONS THEREOF and U.S. Design application Ser. No. 29/523,224, filed on Apr. 7, 2015, entitled CONTAINER, BOTTLE, LOTION DISPENSER AND/OR PORTIONS THEREOF. Each of these applications are herein incorporated by reference in their entirety.

### TECHNICAL FIELD

This document generally relates to a liquid dispenser. More specifically, this disclosure relates to a liquid dispenser comprising a pump for dispensing lotion, creams, milks and/or liquid soap and to systems, kits and method s comprising the same.

### BACKGROUND

Liquid dispensers may be containers and/or bottles that comprise a pump. Generally, the pump is attached to the top of the container and/or bottle and includes a narrow neck. The neck of the pump is susceptible to breaking during shipping and/or operation and is generally not designed for the specific container and/or bottle.

An additional concern with liquid dispensers is that they can be susceptible to trapping build-up of dispensed material in and/or around the neck and/or pump portion of the bottle. This build up may interfere with the pump action and/or promote contamination.

Furthermore, the pump mechanism often detracts from the design and beauty of the container and/or does not lend itself to shrink wrap labeling.

Accordingly, it may be desirable to have a liquid dispenser with a more stable pump configured to resist breaking and/or a pump that integrates with the liquid dispenser in a more cohesive manner to create a unified product. It may also be desirable to have a pump for a liquid dispenser that is more readily operable with a single hand.

### SUMMARY OF EMBODIMENTS

Exemplary embodiments may provide a liquid dispenser comprising a bottle configured to hold a liquid, the bottle comprising a lower portion, an upper portion located adjacent to and above the lower portion, and a neck portion located above the upper portion, the upper portion of the bottle and the neck portion of the bottle being vertically aligned with a central vertical axis; a pump configured to be coupled to the neck portion of the bottle and operable to dispense liquid by moving the pump from an un-depressed position to a depressed position, the pump comprising a pump mechanism, an orifice in fluid communication with the pump mechanism and configured to enable liquid to be dispensed from the dispenser, and a tube in fluid communication with the pump mechanism and extending into the lower portion of the bottle; and a shroud configured to form at least a portion of the outer surface of the pump, the shroud positioned such that in operation, the shroud covers the neck portion of the bottle and a portion of the upper portion of the bottle in the un-depressed position and covers the neck portion and a larger portion of the upper port ion of the bottle in the depressed position.

In exemplary embodiments a radial dimension of the lower portion of the bottle where the lower potion meets the upper portion of the bottle may be substantially identical to a radial dimension of the shroud and slightly less than the radial dimension of the upper portion of the bottle.

In exemplary embodiments the cross section of the shroud, the upper portion and the lower portion of the bottle where the lower potion meets the upper portion of the bottle may be substantially identical.

In exemplary embodiments the upper portion of the bottle and the neck portion of the bottle may be symmetric about the central vertical axis.

In exemplary embodiments substantially all of the upper portion of the bottle may be covered when the pump is depressed.

In exemplary embodiments the difference in radial dimensions between the shroud and the upper portion of the bottle may be less than 3 mm.

In exemplary embodiments the interaction between the shroud and the upper portion of the bottle may provide stability to the pump during operation.

In exemplary embodiments the pump may be configured to be locked to prevent liquid from being dispensed.

In exemplary embodiments the liquid may be lotion or soap.

In exemplary embodiments the liquid may be capable of being stored in the lower portion of the bottle and the upper portion of the bottle.

Exemplary embodiments may provide a liquid dispenser comprising a bottle having a neck; a manually operable reciprocating liquid pump, the pump having a piston rod with reciprocating movement between an extended position and a depressed position for discharging liquid; and an extended cap coupled to the piston rod and configured to move with the piston rod from the extended position to the depressed position, the extended cap comprising a shroud, the shroud surrounding the piston rod and the neck of the bottle throughout the reciprocating movement of the piston rod.

Exemplary embodiments may provide a kit comprising: a first liquid dispenser comprising a pump as described herein; and at least one additional liquid dispenser.

In exemplary embodiments the first liquid dispenser and the at least one additional liquid dispenser may be packaged together.

In exemplary embodiments the at least one additional liquid dispenser may be a squeeze bottle dispenser.

In exemplary embodiments the at least one additional liquid dispenser may be smaller than the first liquid dispenser.

In exemplary embodiments the at least one additional liquid dispenser and the first liquid dispenser may have a substantially similar outward appearance.

Exemplary embodiments may provide a method for distributing a series of liquid dispensers, the method comprising offering a first liquid dispenser with a pump as described herein; and offering at least one additional liquid dispenser, having a substantially similar shape to the first liquid dispenser, in close proximity to the first liquid dispenser.

Exemplary embodiments may provide a series of liquid dispensers having at least one liquid dispenser equipped with a manually operable reciprocating liquid pump and at least one liquid dispenser designed as a squeeze bottle dispenser wherein all the liquid dispensers in the series provide a similar distinct presentation. In exemplary embodiments, on casual observation, it may not be immediately apparent that one of the liquid dispensers in the series is equipped with a manually operable reciprocating liquid pump.

### DESCRIPTION OF THE DRAWINGS

Exemplary embodiments will now be described, by way of example only, with reference to the accompanying drawings in which:

FIG. 1 is an illustration of an exemplary liquid dispenser comprising a pump in accordance with embodiments described herein;

FIG. 2 is an exploded view of an exemplary liquid dispenser comprising a pump in accordance with embodiments described herein;

FIG. 3 is a cross-sectional view of an exemplary pump coupled to a liquid dispenser in accordance with embodiments described herein; and

FIG. 4 is an illustration of an exemplary kit comprising a liquid dispenser with a pump and a substantially similar liquid dispenser with a flip-top in accordance with embodiments described herein.

### DETAILED DESCRIPTION OF EXEMPLARY EMBODIMENTS

As used throughout this document, the term “fluid” is intended to encompass liquids and gases and the term “liquid” is intended to exclude gases. In exemplary embodiments, the term “liquid” may comprise any combination of one or more of a semisolid, semiliquid, or colloids such as gels, aqueous gels, sols, lotions, creams, dispersions, emulsions, ointments, paste, foam, milk, pomade, etc.

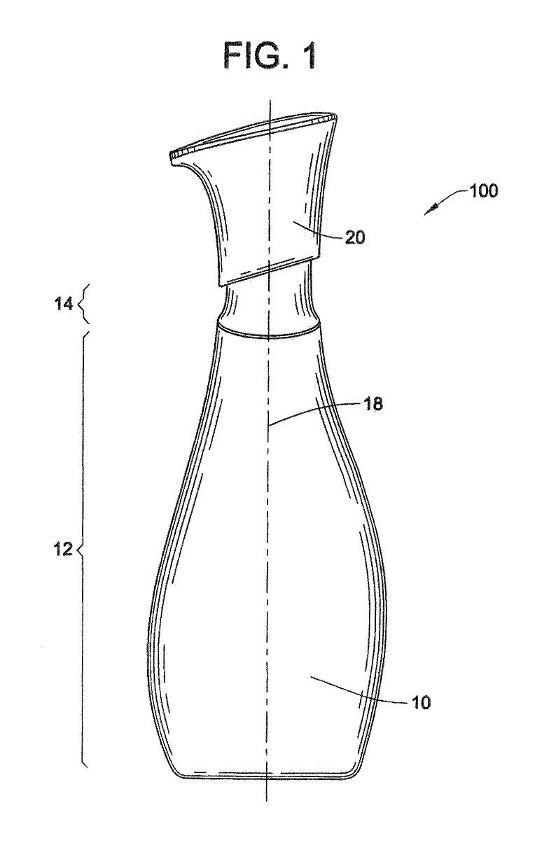

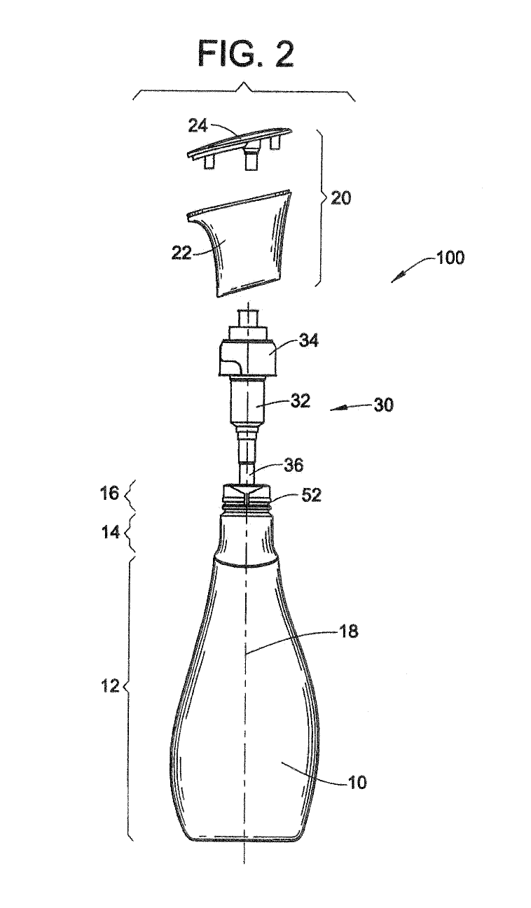

FIG. 1 is an illustration of an exemplary liquid dispenser 100 in accordance with embodiments described herein and FIG. 2 is an exploded view of the exemplary liquid dispenser.

As illustrated, the liquid dispenser comprises a bottle/container 10, a shroud 20, and a pump 30 coupled to the top of the bottle. The bottle may be divided into at least three portions—a lower portion 12, an upper portion 14 located adjacent to and above the lower portion 12, and a neck portion 16 (see, FIG. 2) located above the upper portion 14. In exemplary embodiments, the neck portion 16 and the upper portion 14 may be vertically aligned with a central vertical axis 18. In exemplary embodiments, the lower portion 12 of the bottle 10 may also be vertically aligned with the vertical axis 18. In exemplary embodiments, the lower portion 12 and/or the upper portion 14 may not be symmetric about the central vertical axis 18. In exemplary embodiments, the interface where the lower portion 12 meets the upper portion 14 of the bottle 10 may comprise a step change in the radial dimension of the bottle 10. In exemplary embodiments, the radial dimension of the lower portion 12 of the bottle 10 may continuously vary, i.e., may not comprise a step change. In exemplary embodiments, the radial dimension of the upper portion 14 of the bottle 10 may continuously vary, i.e., may not comprise a step change.

In exemplary embodiments, the shroud 20 may comprise an outer surface 22 and a top portion 24. In exemplary embodiments, the top portion 24 may be integral with the outer surface 22. Alternatively, the top portion 24 may be attachable to the outer surface 22, for example, to aid in the manufacturing process of the shroud 20.

In exemplary embodiments, the neck portion 16 of the bottle 10 may comprise a structure 52 to aid in the attachment of the pump 30 to the bottle 10. In exemplary embodiments, the structure may be threads or a snap fitment, etc. For example, the structure may be a snap fit that comprises a member for aiding in the alignment of the pump 30 with the bottle 10. Additionally, the pump 30 may comprise a dispensing tube 36 configured to extend into the bottle 10 for pumping the liquid out of the bottle during operation of the pump 30. The dispensing tube may be in fluid communication with a pump chamber 32. In exemplary embodiments, the fluid communication between the pump chamber 32 and the dispensing tube 36 may be via a valve (e.g., a one way valve). In exemplary embodiments, the one-way valve may be configured to enable liquid to pass from the dispensing tube 36 and into the pump chamber 32 but not vice-versa.

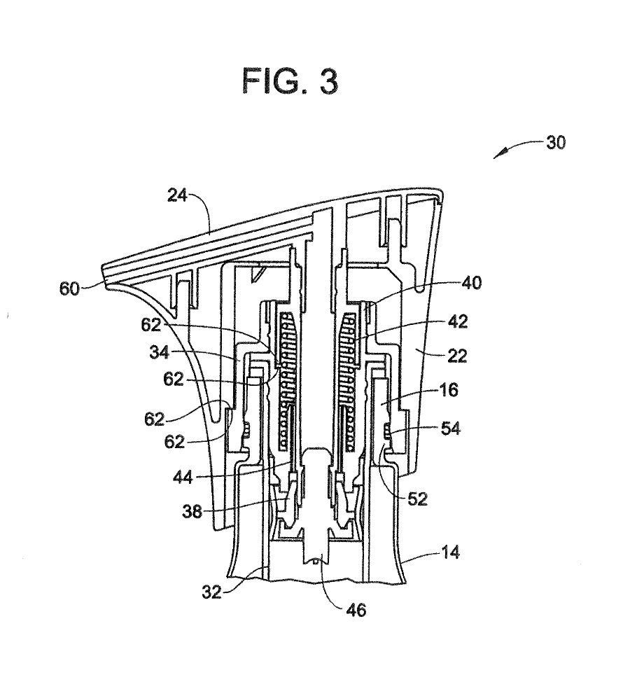

FIG. 3 is a cross-sectional view of an exemplary pump 30 coupled to a liquid dispenser in accordance with embodiments described herein. As illustrated, the pump 30 comprises a mounting cap 36 configured to enable the pump 30 to be coupled to the neck portion 16 of the bottle 10. For example, the mounting cap may comprise a mounting structure (e.g., threads) 54 configured to engage the structure 52 to create a liquid tight connection between the pump 30 and the bottle 10. A piston 38 may be positioned within the pump chamber 32 in a manner that allows the piston 38 to reciprocate between an extended (un-depressed) and depressed position. A biasing structure 40 may also be provided to urge the piston 38 into the extended position. In exemplary embodiments, the biasing structure may comprise a spring 42 and a support structure 44.

In operation, an external downward force (e.g., a user pushing downward) on the top portion 24 of the pump 30. This downward force may cause the piston 38, which is coupled to the shroud 20, to move downward relative to the support structure 44 and the pump chamber 32. This relative downward motion causes compression of the spring 42 and a reduction in the size of the pump chamber 32. As a result of the reduction in size of the pump chamber 32, the liquid in the pump chamber is forced out the top of the chamber and through a valve 46. In exemplary embodiments, the lower portion of the chamber 32 may be configured to restrict the flow of liquid back into the dispensing tube 36 (e.g., by utilizing a one way valve). Accordingly, the volume available for the liquid decreases and the liquid is forced out of the pump 30 through spout 60. After the pump 30 is depressed, it may automatically move back to the extended position since the spring 42 was compressed. This upward motion of the piston creates a suction force that causes additional liquid to travel up the dispensing tube and into the pump chamber 32.

In exemplary embodiments, the spout 60 and/or shroud 20 may be designed to reduce, minimize, prevent, and/or substantially prevent liquid from the spout from becoming trapped in and/or around the neck and/or pump portion of the bottle. Accordingly, in exemplary embodiments, the spout and/or shroud may be configured to reduce interference with the pump action and/or reduce contamination.

In exemplary embodiments, the liquid dispenser may be configured such that the bottle 10 can be shrink wrapped with a label or an adhesive label can be applied to the surface of the bottle. In exemplary embodiments, the bottle may be configured such that the edge of the label is not visible when viewing the bottle from the side. For example, in exemplary embodiments, the edge of the label may be unsightly and/or it may be desirable to obscure the edge. Accordingly, in exemplary embodiments, the edge may be obscured by the shroud 20. In exemplary embodiments, the shroud 20 may obscure the edge of the label in at least one the extended position or depressed position. In exemplary embodiments, the shroud 20 may obscure the edge of the label in both the extended position and depressed position.

In exemplary embodiments, it may be possible to lock the pump 30 such that it cannot be reciprocated. This prevents liquid from being dispensed from the dispenser 100. Such a feature may be beneficial, for example, when the dispenser 100 is being packaged or shipped. The pump 30 illustrated in FIG. 3 is illustrated as being in the locked position. In this embodiment, turning the shroud 20 (and thereby the piston 38) relative to the pump 30, e.g., by 45, 60, 90, 135, or 180 degrees enables the locking mechanism. As illustrated, locking members 62 prevent the piston 38 from moving because the locking members 62 engaged each other before any significant movement of the piston occurs.

As discussed above, in exemplary embodiments the liquid dispenser 100 may comprise a bottle 10 configured to hold a liquid, the bottle may comprise a lower portion 12, an upper portion 14 located adjacent to and above the lower portion 12, and a neck portion 16 located above the upper portion 14. In exemplary embodiments, the upper portion 14 of the bottle 10 and the neck portion 16 of the bottle 10 may be vertically aligned with a central vertical axis 18. The liquid container may further include a pump 30 configured to be coupled to the neck portion 16 of the bottle 10 and may be operable to dispense liquid by moving (reciprocating) the pump from an extended or un-depressed position to a rejected or depressed position. The pump may comprise a pump mechanism, an orifice/spout 60 in liquid communication with the pump mechanism and configured to enable liquid to be dispensed from the dispenser, and a tube 36 in fluid communication with the pump mechanism and extending into the lower portion 12 of the bottle 10. In exemplary embodiments, the liquid dispenser 100 may also comprise a shroud 20 configured to form at least a portion of the outer surface of the pump. The shroud may be positioned such that in operation (and when viewed from the side of the dispenser), the shroud covers the neck portion of the bottle and a portion of the upper portion of the bottle in the un-depressed position and covers the neck portion and an additional portion of the upper portion of the bottle in the depressed position (when viewed from the side). In exemplary embodiment s, the pump 30 may be configured such that the fully depressed position of the pump 30 causes the shroud to cover substantially all of the upper portion of the bottle. In exemplary embodiments, the pump 30 may be configured such that the fully depressed position of the pump 30 causes the shroud to cover at least 40%, at least 45%, at least 50%, at least 55%, at least 60%, at least 65%, at least 70%, at least 75%, at least 80%, at least 85%, at least 90%, at least 95% of the upper portion of the bottle.

In exemplary embodiments a radial dimension (outer surface) of the lower portion 12 of the bottle where the lower portion 12 meets the upper portion 14 of the bottle may be substantially identical to a radial dimension (the outer surface) of the shroud 20 and less than the radial dimension of the outer surface of the upper portion 14. In exemplary embodiments, the upper portion 14 may be of a size and shape such that it fits within the inner surface of the shroud. In this manner, the outer surface of the shroud 20 may form a substantially continuous and smooth transition with the bottle when the pump 30 is depressed and the shroud may be fitted around the upper portion of the bottle. In operation, the shroud may reciprocate with the pump action and telescopically move up and down about the upper port ion of the bottle (or the upper portion of the bottle may move in and out with respect to the shroud during the pump operation without the upper portion of the bottle and/or the neck of the bottle and/or the pump connection to the bottle being exposed.

In exemplary embodiments the cross sectional shape of the shroud 20, the upper portion 14 and the lower portion 12 of the bottle 10 where the lower potion meets the upper portion of the bottle may be substantially identical. In exemplary embodiments, the shape may be circular, oval, elliptical, trapezoidal, triangular, square, rectangular, etc. In exemplary embodiments, the opening formed at the bottom of the shroud 20 may have a shape that is similar to the cross sectional shape. For example, the shape of the opening may be circular, oval, elliptical, trapezoidal, triangular, square, rectangular, etc. In exemplary embodiments, the opening may be substantially perpendicular to the central vertical axis 18 or may form an angle with the central vertical axis 18 (e.g., 20, 30, 45, 60, 75, degrees).

In exemplary embodiments the upper portion 14 of the bottle and the neck portion 16 of the bottle may be symmetric about the central vertical axis 18.

In exemplary embodiments substantially all of the upper portion 14 of the bottle may be covered when the pump is depressed. In exemplary embodiments, more than 75%, 80%, 85%, 90%, 95, or 98% of the upper portion 14 may be covered.

In exemplary embodiments the difference in radial dimensions between the shroud and the upper portion of the bottle may be less than 3 mm. In exemplary embodiments, the difference may be less than 5 mm, 4 mm, 3 mm, 2 mm, or 1 mm.

In exemplary embodiments the interaction between the shroud and the upper portion of the bottle may provide stability to the pump during operation. In other words, in exemplary embodiments, the interaction of the shroud 20 with the upper portion 14 may provide stability to the pump 30 so the pump 30 reciprocates in a substantially vertical manner and with less horizontal force which may cause failure of the pump 30.

In exemplary embodiments the pump may be configured to be locked to prevent liquid from being dispensed. In exemplary embodiments, the locking mechanism may function be turning the shroud by about 90 degrees (e.g., by 45, 60, 90, 135, or 180 degrees) relative to the bottle. In exemplary embodiments, the pump may lock in the extended position, the depressed position, or in a partially depressed position.

In exemplary embodiments the liquid may be lotion or soap. In exemplary embodiments the liquid may be capable of being stored in the lower portion of the bottle and the upper portion of the bottle.

In exemplary embodiments, the liquid dispenser 100 may comprise a bottle 10 having a neck 16 and a manually operable reciprocating liquid pump 30. The pump 30 may have a piston rod 38 with reciprocating movement between an extended position and a depressed position for discharging liquid. An extended cap 22 may be coupled to the piston rod and configured to move with the piston rod from the extended position to the depressed position. In exemplary embodiments, the extended cap may comprise a shroud 24 and the shroud may surround the piston rod 38 and the neck 16 of the bottle throughout the reciprocating movement of the piston rod 38.

In exemplary embodiments, the liquid dispenser 100 may comprise a bottle 10 configured to hold a liquid, the bottle may include a lower portion 12, an upper portion 14 located adjacent to and above the lower portion 12, and a neck portion 16 located above the upper portion 14. In exemplary embodiments, the upper portion 14 of the bottle and the neck portion 16 of the bottle may be vertically aligned with a central vertical axis 18. In exemplary embodiments, the liquid container 100 may comprise a pump 30 configured to be coupled to the neck portion 16 of the bottle 100 and operable to dispense liquid by moving the pump from an un-depressed (extended) position to a depressed position. In exemplary embodiments, the pump may comprise a pump mechanism, an orifice 60 in fluid communication with the pump mechanism and configured to enable liquid to be dispensed from the dispenser, and a tube 36 in fluid communication with the pump mechanism and extending into the lower portion 12 of the bottle. In exemplary embodiments, the liquid container 100 may comprise a shroud 20 configured to form at least a portion of the outer surface of the pump 30 and to shield the pump mechanism, neck portion 16 of the bottle, and a portion of the upper portion 14 of the bottle from dispensed liquid, the shroud 20 positioned such that when viewed at a mid-point plane of the bottle that is perpendicular to the central axis 18, the shroud 20 covers the neck portion 16 of the bottle and a portion of the upper portion 14 of the bottle in the un-depressed position and covers the neck portion 16 and a larger portion of the upper portion 14 of the bottle in the depressed position.

In exemplary embodiments, an upper boundary of the lower portion of the bottle may be angled such that when viewed from the mid-point plane the highest point of the upper boundary of the lower portion extends further up the vertical axis than the lowest point of the upper boundary of the lower portion. In exemplary embodiments, the upper boundary of the lower portion may form a 25, 30, 35, 40, 45, 50, 55, 60, 65, 70, or 75 degree angle relative to an axis perpendicular to the central vertical axis 18. In exemplary embodiments, the angle may be at least 25, at least 30, at least 35, at least 40, at least 45, at least 50, at least 55, at least 60, at least 65, at least 70, or at least 75 degrees.

In exemplary embodiments, the lower boundary of the upper portion of the bottle may be angled complimentary to the angle of the of the upper boundary of the lower portion such that when viewed from the mid-point plane the highest point of the lower boundary of the upper portion aligns with the highest point of the upper boundary of the lower portion and the lowest point of the lower boundary of the upper portion aligns with the lowest point of the upper boundary of the lower portion. In exemplary embodiments, the lower boundary of the upper portion may form a 25, 30, 35, 40, 45, 50, 55, 60, 65, 70, or 75 degree angle relative to an axis perpendicular to the central vertical axis 18. In exemplary embodiments, the angle may be at least 25, at least 30, at least 35, at least 40, at least 45, at least 50, at least 55, at least 60, at least 65, at least 70, or at least 75 degrees.

In exemplary embodiments the largest diameter (or cross-sectional dimension) of the upper portion of the bottle may be smaller than the smallest diameter (or cross-sectional dimension) of the lower portion of the bottle. In exemplary embodiments, the largest diameter (or cross-sectional dimension) of the upper portion of the bottle may be at least 1 mm, or at least 2 mm, or at least 3 mm, or at least 4 mm, or at least 5 mm, or at least 6 mm, or less than 1 mm, or less than 2 mm, or less than 3 mm, or less than 4 mm, or less than 5 mm, or less than 6 mm smaller than the smallest diameter (or cross-sectional dimension) of the lower portion of the bottle.

In exemplary embodiments, the shroud may have a lower edge that may be angled to compliment the angle of the upper boundary of the lower portion of the bottle. In exemplary embodiments, the lower edge of the shroud may form a 25, 30, 35, 40, 45, 50, 55, 60, 65, 70, or 75 degree angle relative to an axis perpendicular to the central vertical axis 18. In exemplary embodiments, the angle may be at least 25, at least 30, at least 35, at least 40, at least 45, at least 50, at least 55, at least 60, at least 65, at least 70, or at least 75 degrees.

Exemplary embodiments may include a kit comprising: a first liquid dispenser as described herein along with a least one additional liquid dispenser.

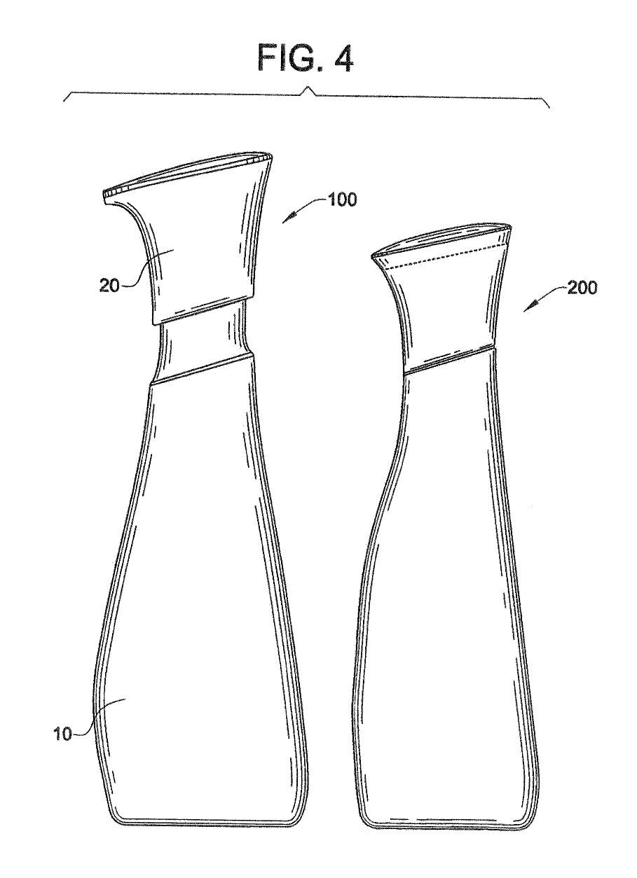

FIG. 4 is an illustration of an exemplary kit comprising a liquid dispenser 100 with a pump and a substantially similar liquid dispenser 200 with a flip-top in accordance with embodiments described herein.

In exemplary embodiments the first liquid dispenser 100 and the at least one additional liquid dispenser 200 may be packaged together. For example, they could be boxed or shrink-wrapped together into a single salable unit.

In exemplary embodiments the at least one additional liquid dispenser 200 may be a squeeze bottle dispenser. In exemplary embodiments, the squeeze bottle may have a flip-top cap.

In exemplary embodiments the at least one additional liquid dispenser 200 may be smaller or larger than the first liquid dispenser.

In exemplary embodiments the at least one additional liquid dispenser and the first liquid dispenser may have a substantially similar outward appearance (e.g., the same shape).

In exemplary embodiments, the first liquid dispenser 100 and the at least one additional liquid dispenser 200 may comprise the same liquid (e.g., lotion or soap) or different liquids (e.g., lotion in one bottle and soap in the other bottle).

In exemplary embodiments, at least one of the bottles 10 may have an asymmetric design. For example, the bottle associated with the pump may be asymmetric or both bottles may be asymmetric, or all of the bottles in the kit may be asymmetric.

Exemplary embodiments may include a method for distributing a series for liquid dispensers. The method may comprise offering a first liquid dispenser as described herein; and offering at least one additional liquid dispenser, having a substantially similar shape to the first liquid dispenser, in close proximity to the first liquid dispenser. For example, multiple liquid dispensers with similar shapes but different colors and sizes may be offered for sale to a customer on the same or adjacent store shelves. Such an arrangement of products may provide beneficial marketing results.

Exemplary embodiments may provide a liquid dispenser comprising a bottle fitted with a manually operable reciprocating liquid pump, the pump having a reciprocating movement between an extended position and a depressed position for discharging liquid. In exemplary embodiments, the smallest outside perimeter of a cross-section perpendicular to the major axis (or major vertical axis) of the bottle in the extended position may be smaller than the smallest outside circumference of the bottle in the depressed position and the smallest outside circumference of the bottle throughout the reciprocating movement may be at least 80% of the smallest outside circumference of the bottle in the depressed position. In exemplary embodiments, the smallest outside circumference of the bottle throughout the reciprocating movement may be at least 60%, at least 65%, at least 70%, at least 75%, at least 80%, at least 85%, at least 90%, at least 95% of the smallest outside circumference of the bottle in the depressed position.

In exemplary embodiments, the smallest outside circumferences of the bottle may extend for a length that is at least 40%, at least 45%, at least 50%, at least 55%, at least 60% of the distance from the extended position to the depressed position.

Exemplary embodiments may provide a liquid dispenser comprising a bottle fitted with a manually operable reciprocating liquid pump, the pump having a reciprocating movement between an extended position and a depressed position for discharging liquid. In exemplary embodiments, the liquid dispenser may have the appearance of a continuous (or substantially continuous) exterior shape in the depressed position. In exemplary embodiments, the smallest outside circumference of the bottle in the extended position is smaller than the smallest outside circumference of the bottle in the depressed position and the smallest outside circumference of the bottle throughout the reciprocating movement is at least 80% of the smallest outside circumference of the bottle in the depressed position. In exemplary embodiments, the smallest outside circumference of the bottle throughout the reciprocating movement may be at least 60%, at least 65%, at least 70%, at least 75%, at least 80%, at least 85%, at least 90%, at least 95% of the smallest outside circumference of the bottle in the depressed position.

While exemplary embodiments have been shown and described herein, it will be obvious to those skilled in the art that such embodiments are provided by way of example only. It is intended that the following claims define the scope of the invention and that methods and structures within the scope of these claims and their equivalents be covered thereby.

1. A liquid dispenser comprising:
a bottle configured to hold a liquid, the bottle comprising a lower portion, an upper portion located adjacent to and above the lower portion, and a neck portion located above the upper portion, the upper portion of the bottle and the neck portion of the bottle being vertically aligned with a central vertical axis;
a pump configured to be coupled to the neck portion of the bottle and operable to dispense liquid by moving the pump from an un-depressed position to a depressed position, the pump comprising a pump mechanism, an orifice in fluid communication with the pump mechanism and configured to enable liquid to be dispensed from the dispenser, and a tube in fluid communication with the pump mechanism and extending into the lower portion of the bottle; and
a shroud configured to form at least a portion of the outer surface of the pump, the shroud positioned such that in operation, the shroud covers the neck portion of the bottle and a portion of the upper portion of the bottle in the un-depressed position and covers the neck portion and a larger portion of the upper portion of the bottle in the depressed position.

2. The liquid dispenser of claim 1, wherein a radial dimension of the lower portion of the bottle where the lower potion meets the upper portion of the bottle is substantially identical to a radial dimension of the shroud and slightly less than the radial dimension of the upper portion of the bottle.

3. The liquid dispenser of claim 1, wherein the cross section of the shroud, the upper portion and the lower portion of the bottle where the lower potion meets the upper portion of the bottle are substantially identical.

4. The liquid dispenser of claim 1, wherein the upper portion of the bottle and the neck portion of the bottle are symmetric about the central vertical axis.

5. The liquid dispenser of claim 1, wherein substantially all of the upper portion of the bottle is covered when the pump is depressed.

6. The liquid dispenser of claim 1, wherein the difference in radial dimensions between the shroud and the upper portion of the bottle is less than 3 mm.

7. The liquid dispenser of claim 1, wherein the interaction between the shroud and the upper portion of the bottle provides stability to the pump during operation.

8. The liquid dispenser of claim 1, wherein the pump is configured to be locked to prevent liquid from being dispensed.

9. The liquid dispenser of claim 1, wherein the liquid is lotion.

10. The liquid dispenser of claim 1, wherein the liquid is capable of being stored in the lower portion of the bottle and the upper portion of the bottle.

11. A liquid dispenser comprising:
a bottle having a neck;
a manually operable reciprocating liquid pump, the pump having a piston rod with reciprocating movement between an extended position and
a depressed position for discharging liquid; and
an extended cap coupled to the piston rod and configured to move with the piston rod from the extended position to the depressed position, the extended cap comprising a shroud, the shroud surrounding the piston rod and the neck of the bottle throughout the reciprocating movement of the piston rod.

12. A liquid dispenser comprising:
a bottle fitted with a manually operable reciprocating liquid pump, the pump having a reciprocating movement between an extended position and a depressed position for discharging liquid;
wherein the smallest outside circumference of the bottle in the extended position is smaller than the smallest outside circumference of the bottle in the depressed position and the smallest outside circumference of the bottle throughout the reciprocating movement is at least 80% of the smallest outside circumference of the bottle in the depressed position.

13. The liquid dispenser of claim 12, wherein the smallest outside circumferences of the bottle extends for a length that is at least 50% of the distance from the extended position to the depressed position.

14. A liquid dispenser comprising:
a bottle fitted with a manually operable reciprocating liquid pump, the pump having a reciprocating movement between an extended position and a depressed position for discharging liquid;
wherein the liquid dispenser has the appearance of a continuous exterior shape in the depressed position; and
wherein the smallest outside circumference of the bottle in the extended position is smaller than the smallest outside circumference of the bottle in the depressed position and the smallest outside circumference of the bottle throughout the reciprocating movement is at least 80% of the smallest outside circumference of the bottle in the depressed position.

15. A liquid dispenser comprising:
a bottle configured to hold a liquid, the bottle comprising a lower portion, an upper portion located adjacent to and above the lower portion, and a neck portion located above the upper portion, the upper portion of the bottle and the neck portion of the bottle being vertically aligned with a central vertical axis;
a pump configured to be coupled to the neck portion of the bottle and operable to dispense liquid by moving the pump from an un-depressed position to a depressed position, the pump comprising a pump mechanism, an orifice in fluid communication with the pump mechanism and configured to enable liquid to be dispensed from the dispenser, and a tube in fluid communication with the pump mechanism and extending into the lower portion of the bottle; and
a shroud configured to form at least a portion of the outer surface of the pump and to shield the pump mechanism, neck portion of the bottle, and a portion of the upper portion of the bottle from dispensed liquid, the shroud positioned such that when viewed at a mid-point plane of the bottle that is perpendicular to the central axis, the shroud covers the neck portion of the bottle and a portion of the upper portion of the bottle in the un-depressed position and covers the neck portion and a larger portion of the upper portion of the bottle in the depressed position.

16. The liquid dispenser of claim 15, wherein an upper boundary of the lower portion of the bottle is angled such that when viewed from the mid-point plane the highest point of the upper boundary of the lower portion extends further up the vertical axis than the lowest point of the upper boundary of the lower portion.

17. The liquid dispenser of claim 16, wherein the lower boundary of the upper portion of the bottle is angled complimentary to the angle of the of the upper boundary of the lower portion such that when viewed from the mid-point plane the highest point of the lower boundary of the upper portion aligns with the highest point of the upper boundary of the lower portion and the lowest point of the lower boundary of the upper portion aligns with the lowest point of the upper boundary of the lower portion.

18. The liquid dispenser of claim 17, wherein the largest diameter of the upper portion of the bottle is smaller than the smallest diameter of the lower portion of the bottle.

19. The liquid dispenser of claim 18, wherein the shroud has a lower edge, the lower edge of the shroud being angled to compliment the angle of the upper boundary of the lower portion of the bottle.

20. A kit comprising:
a first liquid dispenser according to claim 1; and
a least one additional liquid dispenser.

21. The kit of claim 20, wherein the first liquid dispenser and the at least one additional liquid dispenser are packaged together.

22. The kit of claim 20, wherein the at least one additional liquid dispenser is a squeeze bottle dispenser.

23. The kit of claim 20, wherein the at least one additional liquid dispenser is smaller than the first liquid dispenser.

24. The kit of claim 20, wherein the at least one additional liquid dispenser and the first liquid dispenser have a substantially similar outward appearance.

25. A method for distributing a series of liquid dispensers, the method comprising:
offering a first liquid dispenser according to claim 1; and
offering at least one additional liquid dispenser, having a substantially similar shape to the first liquid dispenser, in close proximity to the first liquid dispenser.
